(19) United States
(12) Patent Application Publication
(10) Pub. No.: US 2010/0078955 A1
(43) Pub. Date: Apr. 1, 2010

(54) EXTENDER BED FOR PICK-UP TRUCKS

(76) Inventor: HOWARD G. SMITH, NORCO, CA (US)

Correspondence Address: Loza & Loza LLP, 305 North Second Ave., #127, Upland, CA, 91786, US

(21) Appl. No.: 12/568,438

(22) Filed: Sep. 28, 2009

Related U.S. Application Data
(60) Provisional application No. 61/194,390, filed on Sep. 26, 2008.

(51) Int. Cl. B62D 33/08

(52) U.S. Cl. 296/26.11

(57) ABSTRACT

Embodiments of the invention are directed to a truck bed accessory for extending the length of a truck bed. In one embodiment, the truck bed accessory includes a bed panel and two side panels hingedly connected thereto. In a closed position, the two side panels may fold into the bed panel. In an open position, the two side panels may fold outwardly relative to the bed panel such that the two side panels are positioned approximately 90 degrees and perpendicular relative to the bed panel. In some embodiments, the bed panel may hingedly connect to a tailgate of a truck.

This application claims priority to U.S. Provisional Application No. 61/194,390 filed Sep. 26, 2008 and hereby incorporated by reference.

### FIELD OF THE INVENTION

Truck bed accessories.

### BACKGROUND OF THE INVENTION

A full-size pickup is a large truck suitable for hauling heavy loads and performing other functions. Generally, most full-size trucks can carry at least 1000 pounds in the rear bed, with some capable of over fives times that much. Generally, trucks are front-engine and four-wheel drive optional and many use a live axle with leaf springs in the rear. A smaller version, the compact pickup truck, is the most widespread type of pickup truck worldwide. It is built like a mini version of a two-axle heavy truck with a frame providing structure, a conventional cab, a leaf spring suspension on the rear wheels and a four or six cylinder engine. The compact pickup was introduced to North America in the 1960s by Japanese manufacturers.

The evolution of the pickup truck in the U.S. market has proved to be phenomenal. It has gone from a bare-bones workhorse to a well-equipped style version of the first pickup trucks. Its area of influence has expanded from a limited commercial market to a huge market covering all sorts of uses and lifestyles. In 10 years, annual U.S. car sales dropped from 10.2 million to 8.5 million units. At the same time, truck sales wend from 5 million to nearly 7 million units a year. A lot of those trucks are high-end vehicles used primarily for personal transportation by affluent people. In today's market that means equipping a truck with extras. Extended cab models now account for more than 70 percent of the mix and provide additional passenger space by virtue of the extended cab.

The popularity of pickup trucks was evidenced a few years ago when, for the first time in history, light truck sales edged ahead of car sales in the United States. The popularity of pickup trucks is attributable to the need of many people for a versatile vehicle which can be used to haul all types of cargo and provide transportation for the family. As noted earlier, many pickup trucks now have extended cabs, allowing for more passengers.

In exchange for extended cabs, many auto manufacturers have decreased the length of the bed. As a result, those who use their trucks for dual purposes—transportation of more than 2 persons and transportation of work items surpassing the length of the bed—may find the bed too short. Leaving the tailgate down while the vehicle is open presents safety issues.

Consequently, a device and method for extending the bed of a truck is needed.

### SUMMARY OF THE INVENTION

A truck bed accessory, consisting essentially of: (i) a bed panel having two equal opposite edges of a first length and two equal opposite edges of a second length, the first length longer than the second length, one of the first length edges adapted to hingedly connect to tailgate of a truck bed; (ii) a first side panel having two equal opposite edges of a first length and two equal opposite edges of a second length, the first length longer than the second length, the first side panel hingedly connected to one edge of the second length of the bed panel; and (iii) a second side panel having two equal opposite edges of a first length and two equal opposite edges of a second length, the first length longer than the second length, the second side panel hingedly connected to the other edge of the second length of the bed panel is herein disclosed.

The bed panel may have a bed panel inner surface and a bed panel outer surface. The (i) the first side panel may have a first side panel inner surface and a first side panel outer surface and (ii) the second side panel may have a second side panel inner surface and a second side panel outer surface. In a closed position, the first and second side panels may be folded into the bed panel toward a center line bisecting the bed panel, the first and second side panel inner surfaces facing the bed panel inner surface. In an open position, the first and second side panels may be folded outwardly relative to the bed panel about 90 degrees and perpendicular thereto. The outer surface of the bed panel may include at least two handholds equidistant from one another relative to a center line bisecting the bed panel.

The first side panel may include a connecting mechanism on the edge opposite the edge hingedly connected to one edge of the second length of the bed panel. Additionally, the second panel may include a connecting mechanism on the edge opposite the edge hingedly connected to the other edge of the second length of the bed panel. The connecting member may be a hook or a latch.

The truck bed accessory may further include at least two slide rails for sliding the truck bed accessory from a first position to a second position relative to a tailgate. The first position is the wherein one of the first length edges is approximate to a bottom edge of the tailgate of a truck bed. The second position is the wherein one of the first length edges is approximate to a top edge of the tailgate of a truck bed. The truck bed assembly is adapted to rotate 180 degrees relative to the tailgate, the tailgate in an open position.

### BRIEF DESCRIPTION OF THE DRAWINGS

FIG. 1 illustrates a perspective view of a prior art bed of a truck with a tailgate in a closed position.

FIG. 2 illustrates a perspective view of a prior art bed of a truck with a tailgate in an open position.

FIG. 3 illustrates a perspective view of truck bed accessory according to an embodiment of the invention.

FIG. 4 illustrates a perspective view of a truck bed with a truck bed accessory attached to the tailgate with one side panel in a closed position and the other side panel is a partially open position according to an embodiment of the invention.

FIG. 5 illustrates a perspective view of a truck bed with a truck bed accessory attached to the tailgate with both panels in an open position according to an embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

Embodiments of the invention are directed to a truck bed accessory for extending the length of a truck bed. In one embodiment, the truck bed accessory includes a bed panel and two side panels hingedly connected thereto. In a closed position, the two side panels may fold into the bed panel. In an open position, the two side panels may fold outwardly relative to the bed panel such that the two side panels are positioned approximately 90 degrees and perpendicular relative to the bed panel. In some embodiments, the bed panel may hingedly connect to a tailgate of a truck.

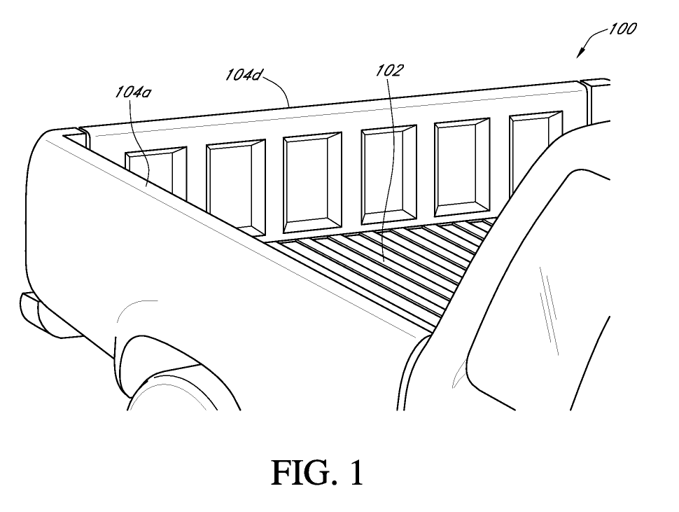

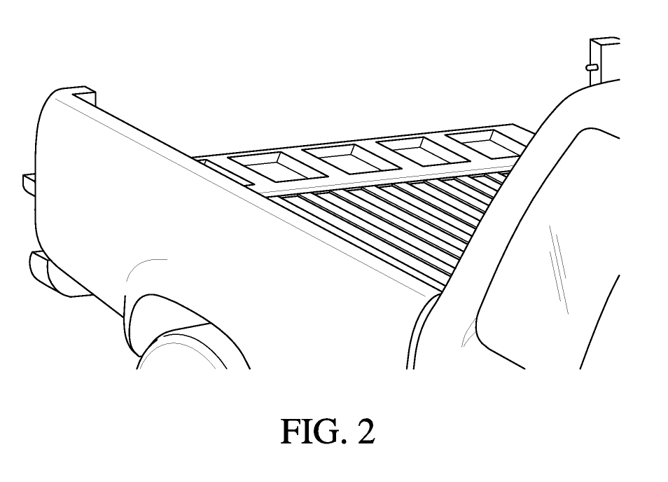

FIG. 1 illustrates a perspective view of a prior art bed of a truck with a tailgate in a closed position. As shown, the of a truck 100 generally comprises an uncovered bed 102, however, it should be appreciated that the bed 102 may be covered with a truck bed cover (not shown). Generally, the bed 100 is approximately rectangular in configuration. Generally, the bed 102 is partially enclosed by four surfaces perpendicular to the bed 102, namely, two stationary side panels 104a and 104b (not shown), a front panel 104c (not shown) and a back panel 104d. The back panel 104d is typically referred to as a “tailgate,” hereinafter used interchangeably. The tailgate 104d is typically hingedly connected to the back-most edge of the bed 102. In a closed position, the tailgate 104d is perpendicular relative to the bed 102. In an open position, the tailgate 104d is parallel, or approximately within the same plane as, the bed 102. FIG. 2 illustrates a perspective view of a prior art bed of a truck with a tailgate in an open position.

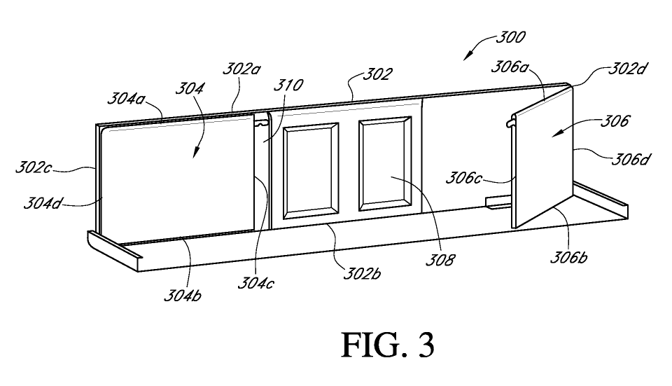

FIG. 3 illustrates a perspective view of truck bed accessory according to an embodiment of the invention. The truck bed accessory 300 may include a bed panel 302 having two equal opposite edges 302a and 302b of a first length and two equal opposite edges 302c and 302d of a second length. In one embodiment, the edges 302a, 302b are longer than the edges 302c, 302d. For example, the edges 302a, 302b may be approximately fifty-five (55) inches in length and the edges 302c, 302d may be approximately twenty-four (24) inches in width; however, other suitable lengths/widths are within the scope of the invention and may approximate the length/width of any commercially available tailgate. In one embodiment, at least one edge 302a, 302b, e.g., edge 302b, may connect to the uppermost edge of a tailgate of a truck bed. The mechanism of connection may be bolts, hinges, hooks or any other suitable means of connection.

Continuing to refer to FIG. 3, the truck bed accessory 300 may further include a first side panel 304 having two equal opposite edges 304a and 304b of a first length and two equal opposite edges 304c and 304d of a second length. In one embodiment, the edges 304a, 304b are longer than the edges 304c, 304d. For example, the edges 304a, 304b may be approximately twenty-four (24) inches in length and the edges 304c, 304d may be approximately between sixteen (16) and twenty-four (36) inches in width; however, other suitable lengths/widths are within the scope of the invention. In one embodiment, at least one edge 304c, 304d, e.g., edge 304d, may hingedly connect to edge 302c of the base panel 302. The connection may be such that, in a closed position, the first side panel 304 folds into the base panel 302 and, in an open position, the first panel 304 folds away from the base panel 302 to approximately 90 degrees thereto and perpendicular thereto.

Continuing to refer to FIG. 3, the truck bed accessory 300 may further include a second side panel 306 having two equal opposite edges 306a and 306b of a first length and two equal opposite edges 306c and 306d of a second length. In one embodiment, the edges 306a, 306b are longer than the edges 306c, 306d. For example, the edges 306a, 306b may be approximately twenty-four (24) inches in length and the edges 306c, 306d may be approximately between sixteen (16) and twenty-four (36) inches in width; however, other suitable lengths/widths are within the scope of the invention. According to some embodiments, the first side panel 304 and the second panel 306 are the same size. Similar to the side panel 304, at least one edge 306c, 306d, e.g., edge 306d, may hingedly connect to the edge 302c of the base panel 302. The connection may be such that, in a closed position, the second side panel 306 folds into the base panel 302 and, in an open position, the first panel 306 folds away from the base panel 306 to approximately 90 degrees thereto and perpendicular thereto.

According to embodiments of the invention, the truck bed accessory 300 may be made of sheet metal or any other suitable material. In any embodiment, the material should be light-weight yet sturdy and resistant to environmental conditions. When the truck bed accessory 300 is attached to a tailgate, the first and second side panels 304, 306 may fold into the bed panel 302, i.e., when in a closed position. That is, inner surfaces of the first and second side panels 304, 306 may face an inner surface of the bed panel 302 toward a center line bisecting the bed panel 302.

In one embodiment, the truck bed accessory 300 may slide from a first position, i.e., the bottom edge of the tailgate, to a second position, i.e., the top edge of the tailgate. Once the truck bed accessory 300 is slid to the second position, the truck bed accessory 300 may rotate within about 180 degrees. That is, the truck bed accessory 300 may rotate about 90 degrees downwardly relative to the tailgate (in a horizontal position) to allow for loading of materials into the bed of the truck. The truck bed accessory 300 may rotate about 90 degrees upwardly relative to the tailgate (in a horizontal position) to extend the bed of the truck. Sliding of the truck bed accessory 300 may be accomplished using slide rails or any other equivalent means known by one of ordinary skill in the art.

According to some embodiments of the invention, when in a closed position, edges 304c and 306c of the first and second side panels 304, 306 may approach a center raised panel 308 wherein a recess 310 is defined by edges 304c and 306c and parallel edges of the raised panel 308. Each recess 310 provides a means for a user to lift the first and second side panels 304, 306 when a user wishes to open the truck bed accessory 300 by lifting the first and second side panels 304, 306 away from the bed panel 302.

In another embodiment, the first and second side panels 304, 306 may overlap one another. In this manner, the truck bed accessory 300 may totally enclose the extended space by taking into account the width of the bed panel 302 and the width of the tailgate when in an open position.

According to some embodiments of the invention, one or more handholds (not shown) may be on an outer surface of the truck bed accessory 300. In one embodiment, the handholds are equidistant from one another relative to a center line bisecting the bed panel 302. These handles allow a user to position the truck bed accessory 300 to a tailgate and connect it thereto.

According to some embodiments of the invention, edges 304c and 306c of the first and second side panels 304, 306 may include a connecting mechanism 312 to connect the first and second side panels 304, 306 to corresponding side panels of a truck bed when the truck bed accessory is in an open position. The connecting mechanism 312 may be a hook or a latching mechanism or other suitable securing mechanism.

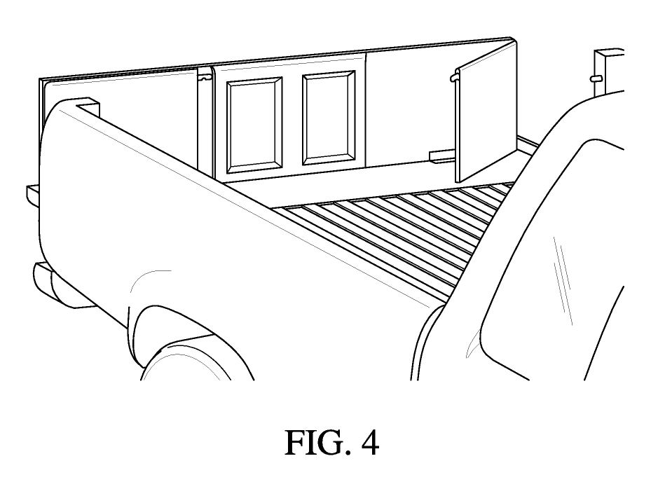

FIG. 4 illustrates a perspective view of a truck bed with a truck bed accessory attached to the tailgate with one side panel in a closed position and the other side panel is a partially open position according to an embodiment of the invention.

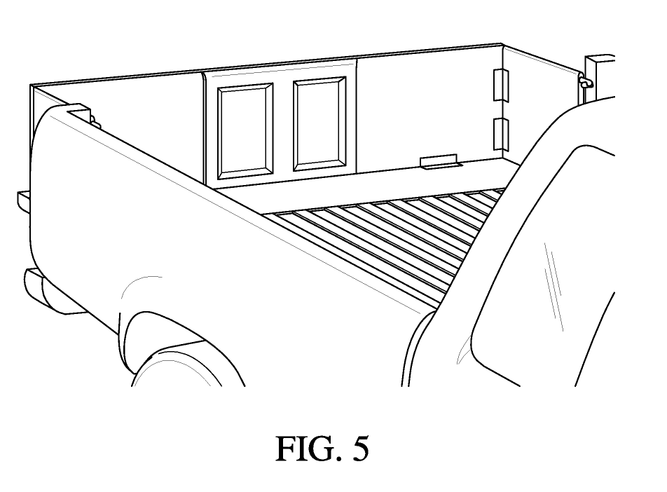

FIG. 5 illustrates a perspective view of a truck bed with a truck bed accessory attached to the tailgate with both side panels in an open position according to an embodiment of the invention.

Advantageously, the truck bed accessory, also called a truck bed extender, according to embodiments of the invention allow a user to extend the length of a truck bed when necessary. Since the truck bed extender is removable and lightweight, it can be attached to a tailgate of a truck at any time. However, the truck bed extender may also be left attached to the tailgate since it does not interfere with the operation of opening and closing the tailgate. Thus, unlike prior art truck bed extenders, the truck bed extender according to embodiments of the invention does not have to be repeatedly attached and removed, but, rather, may be left in place and extended when required. The truck bed extender may be used by, for example, contractors or plumbers when having to transport building materials of excess length.

While certain exemplary embodiments have been described and shown in the accompanying drawings, it is to be understood that such embodiments are merely illustrative of and not restrictive on the broad invention, and that this invention is not to be limited to the specific constructions and arrangements shown and described, since various other modifications may occur to those ordinarily skilled in the art.

What is claimed is:

1. A truck bed accessory, comprising:
a bed panel having two equal opposite edges of a first length and two equal opposite edges of a second length, the first length longer than the second length, one of the first length edges adapted to hingedly connect to a tailgate of a truck bed;
a first side panel having two equal opposite edges of a first length and two equal opposite edges of a second length, the first length longer than the second length, the first side panel hingedly connected to one edge of the second length of the bed panel; and
a second side panel having two equal opposite edges of a first length and two equal opposite edges of a second length, the first length longer than the second length, the second side panel hingedly connected to the other edge of the second length of the bed panel.

2. The truck bed accessory of claim 1 wherein the bed panel has a bed panel inner surface and a bed panel outer surface.

3. The truck bed accessory of claim 2 wherein (i) the first side panel has a first side panel inner surface and a first side panel outer surface and (ii) the second side panel has a second side panel inner surface and a second side panel outer surface.

4. The truck bed accessory of claim 3 wherein, in a closed position, the first and second side panels are folded into the bed panel toward a center line bisecting the bed panel, the first and second side panel inner surfaces facing the bed panel inner surface.

5. The truck bed accessory of claim 4 wherein, in an open position, the first and second side panels are folded outwardly relative to the bed panel about 90 degrees and perpendicular thereto.

6. The truck bed accessory of claim 2 wherein the outer surface of the bed panel includes at least two handholds equidistant from one another relative to a center line bisecting the bed panel.

7. The truck bed accessory of claim 1 wherein the first side panel includes a connecting mechanism on the edge opposite the edge hingedly connected to one edge of the second length of the bed panel.

8. The truck bed accessory of claim 7 wherein the connecting member is a hook or a latch.

9. The truck bed accessory of claim 1 wherein the second panel includes a connecting mechanism on the edge opposite the edge hingedly connected to the other edge of the second length of the bed panel.

10. The truck bed accessory of claim 9 wherein the connecting member is a hook or a latch.

11. The truck bed accessory of claim 1, further comprising, at least two slide rails for sliding the truck bed accessory from a first position to a second position relative to a tailgate.

12. The truck bed accessory of claim 11 wherein the first position is the wherein one of the first length edges is approximate to a bottom edge of the tailgate of a truck bed.

13. The truck bed accessory of claim 12 wherein the second position is the wherein one of the first length edges is approximate to a top edge of the tailgate of a truck bed.

14. The truck bed accessory of claim 13 wherein the truck bed assembly is adapted to rotate 180 degrees relative to the tailgate, the tailgate in an open position.
